(19) United States
(12) Patent Application Publication
(10) Pub. No.: US 2003/0071902 A1
(43) Pub. Date: Apr. 17, 2003

(54) System, devices, and methods for switching between video cameras

(76) Inventors: Paul G. Allen, Mercer Island, WA (US); Geoffrey M. Smith, Palo Alto, CA (US); Robert E. Novak, Santa Clara, CA (US)

Correspondence Address: DIGEO, INC C/O STOEL RIVES LLP, 201 SOUTH MAIN STREET, SUITE 1100, ONE UTAH CENTER, SALT LAKE CITY, UT, 84111, US

(21) Appl. No.: 09/975,564

(22) Filed: Oct. 11, 2001

(51) Int. Cl. H04N 5/232

(52) U.S. Cl. 348/211.11

(57) ABSTRACT

Improved systems, devices, and methods for switching viewing between multiple video cameras. In one embodiment, switching between cameras is accomplished at lower cost and higher reliability by providing a system, devices and methods that utilize power switches, instead of high bandwidth switches. Embodiments provide local and remote access control installations to monitor multiple camera locations. Select specific embodiments verify user and/or monitoring site identity and/or authorization prior to permitting monitoring. In some specific embodiments, still picture monitoring may be utilized to decrease bandwidth requirements.

### BACKGROUND OF THE INVENTION

1. Field of the Invention

The present invention relates generally to electronics and more particularly to video systems.

2. Description of Background Art

At a time when many in our society are increasing enjoying greater wealth and status, in large part the benefit of the investment in new technology, a darker element to our society has also become increasingly apparent. Sadly, one need not go too far to hear reports that crime is on the rise. It seems that every other news story has to do with crime. While many crimes are crimes against property, such as theft, burglary, and the like, more frightening types of crimes involving violence are also become widespread. Crime has become part of the American national conscience. Mobster movies, crime television shows, and other elements of pop culture have come to reflect the violent elements within our society. Even persons in small towns lock their windows and doors at night. Americans spend more on security devices, guard dogs, security lighting and so forth than ever before in history. Recently, there has been a widespread concern about national security from terrorism.

One type of security device that has experienced increased use in recent years is the video monitoring system. In conventional video monitoring systems, one or more cameras are positioned in strategic areas, such as hallways, entrances, and so forth. Typically, these cameras feed video monitors that are located in a central point, and viewed by a security guard, or guards. The idea being that the security guard, upon noticing suspicious activity, will alert the appropriate authorities, or dispatch a member of the security force to deal with the situation. Another philosophy is to make a continuous video recording from the video cameras, so that a record exists of any illegal activity. The record can be replayed in a courtroom to help the authorities prove a case against an alleged wrongdoer. Often, the cameras are mounted to be conspicuous, so that potential wrongdoers know that their actions will be recorded for use as evidence if they are later caught, in the hopes that this will thwart the activity prior to its occurrence.

Various disadvantages exist in the conventional approaches. For example, according to conventional video monitoring technology, cameras are often wired to a central video monitoring system. In the case where each camera input is displayed continuously on a video monitor, the same number of video monitors as cameras is required. Alternatively, a single video monitor can be time shared among two or more cameras. Often, however, this approach requires the use of complex and expensive video signal switches.

Further, in conventional approaches, the cameras are wired to the monitors in the central area. The cabling required to create such systems makes installation cumbersome and increases cost substantially. Another disadvantage to conventional systems is that the monitoring is typically done on site.

### BRIEF DESCRIPTION OF THE DRAWINGS

Non-limiting and non-exhaustive embodiments of the present invention are described with reference to the following figures, wherein like reference numerals refer to like parts throughout unless otherwise specified.

FIG. 1A depicts a diagram of a conventional camera switching system.

FIG. 1B depicts a block diagram of a broadband multiplexer that may be used in the conventional camera switching system.

FIG. 1C depicts a diagram of a camera switching system in accordance with a specific embodiment of the invention.

FIG. 2A illustrates a block diagram of an example arrangement of an interactive video casting system in which video monitoring is implemented in accordance with a specific embodiment of the present invention.

FIG. 2B illustrates a block diagram showing another example of an interactive video casting system in which video monitoring is implemented in accordance with a specific embodiment of the present invention.

FIG. 2C illustrates a block diagram showing a further example of an interactive video casting system in which video monitoring is implemented in accordance with a specific embodiment of the present invention.

FIG. 3 illustrates a block diagram of a representative set top box in accordance with a specific embodiment of the present invention.

FIG. 4 illustrates a flowchart of representative processing in a camera controller in accordance with a specific embodiment of the present invention.

FIG. 5 illustrates a flowchart of representative processing in a local or remote access controller in accordance with a specific embodiment of the present invention.

FIG. 6 illustrates a user interface for switching between multiple cameras in accordance with a specific embodiment of the present invention.

### DESCRIPTION OF THE SPECIFIC EMBODIMENTS

The present invention provides improved systems, devices, and methods for switching viewing between multiple video cameras. In one embodiment, switching between cameras is accomplished at lower cost and higher reliability by providing a system, devices and methods that utilize power switches, instead of high bandwidth switches. Embodiments provide local and remote access control installations to monitor multiple camera locations. Select specific embodiments verify user and/or monitoring site identity and/or authorization prior to permitting monitoring. In some specific embodiments, still picture monitoring may be utilized to decrease bandwidth requirements.

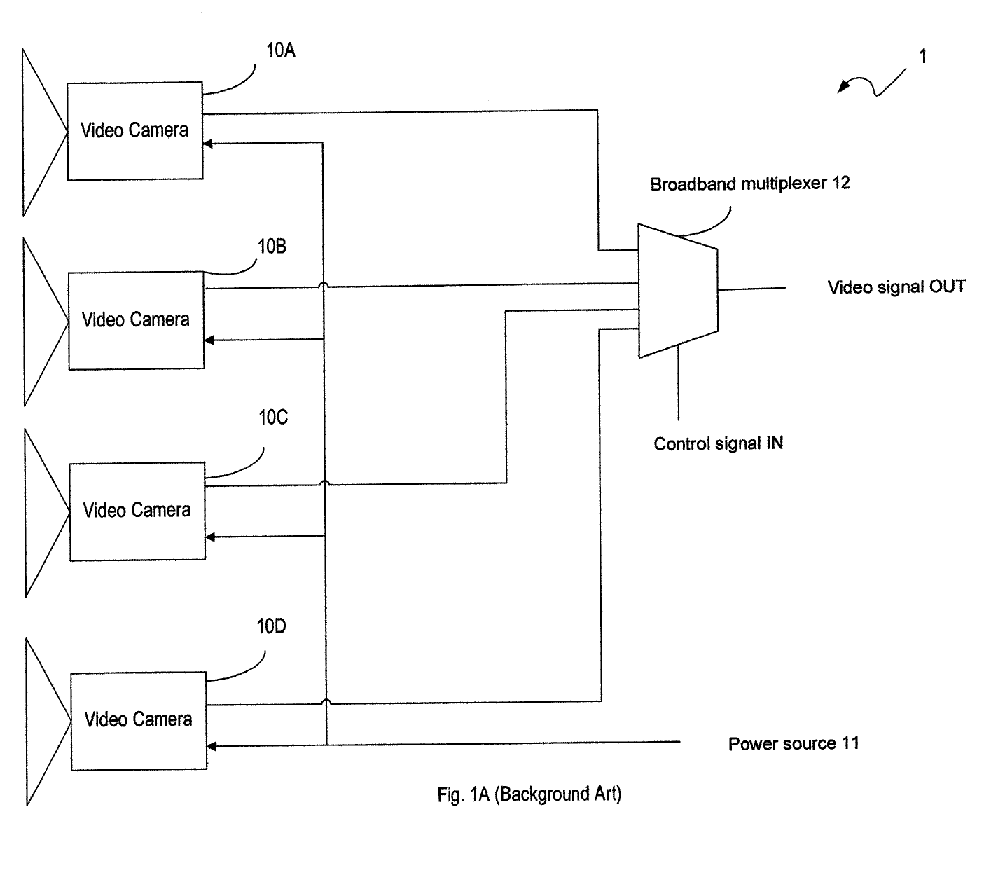

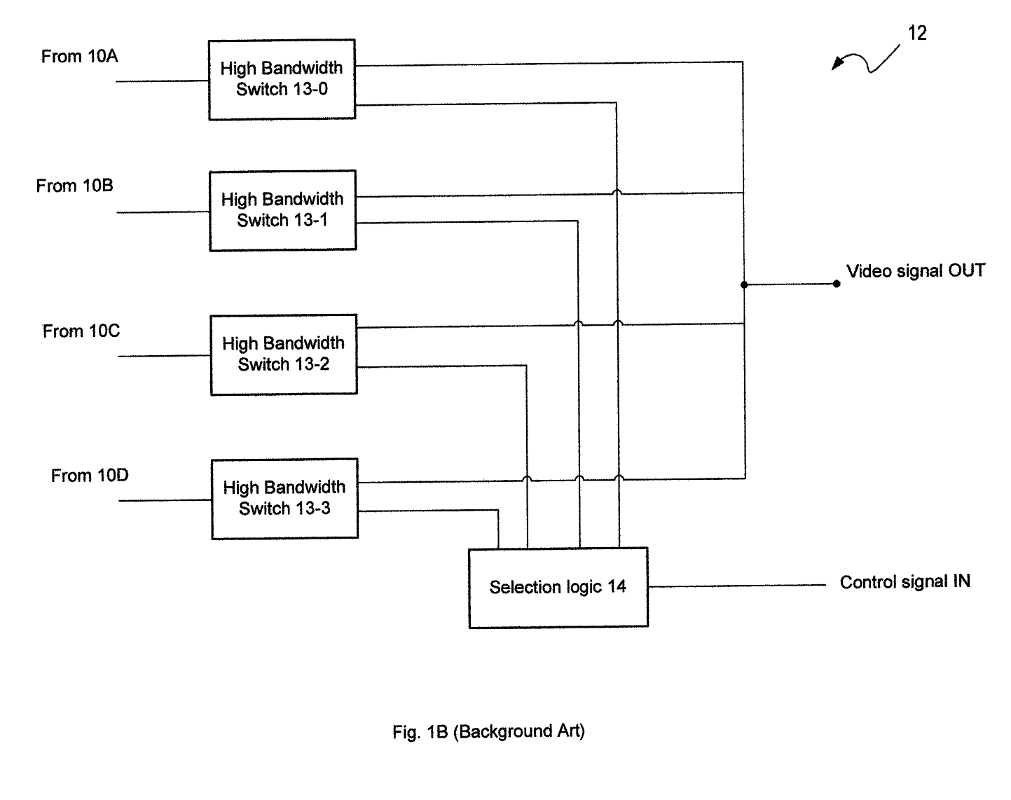

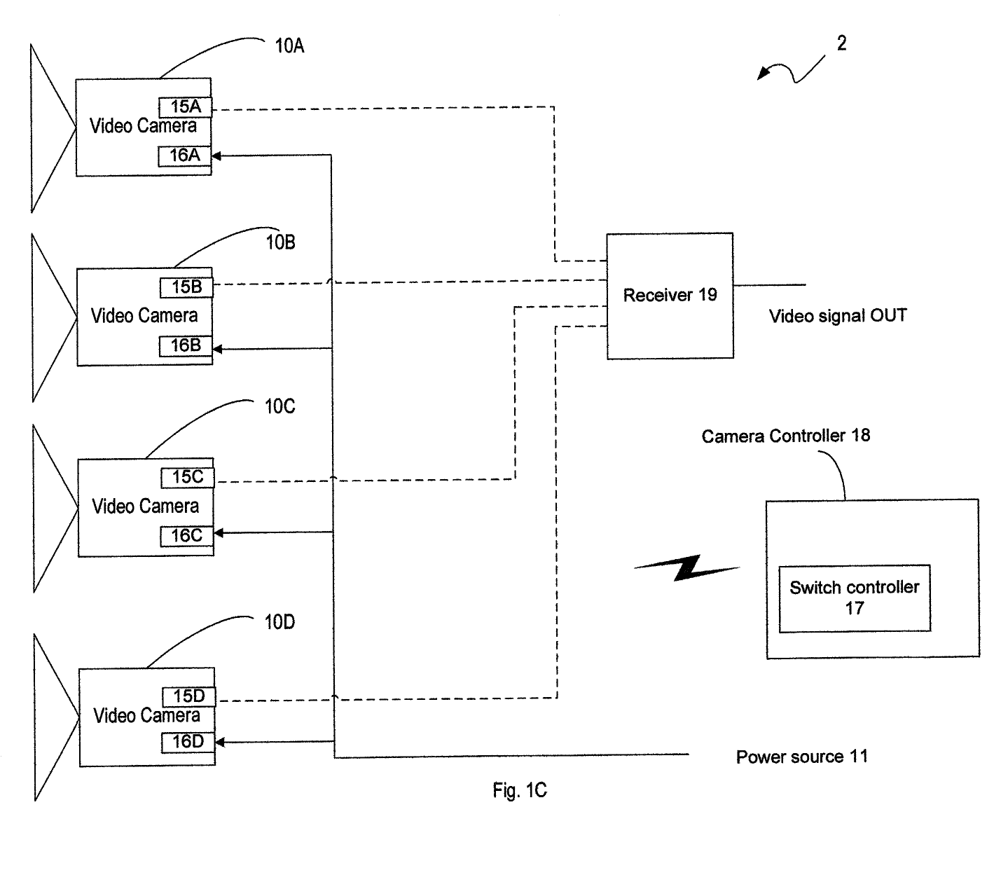

FIG. 1A depicts a diagram of a conventional camera switching system 1. As shown by FIG. 1A, the conventional system 1 comprises multiple video cameras, for example, 10A, 10B, 10C, and 10D. Each camera draws continuous power for its operation from a power source 12. The power source 11 typically comprises line power that is at around 115 to 120 volts AC in the United States. Alternatively, DC power may be used for cameras that operate using DC power. Each camera outputs its video signal output to a broadband multiplexer 12. Due to the high-frequency nature of the video signals, the broadband multiplexer 12 tends to be a relatively costly and troublesome component. The broadband multiplexer 12 comprises a circuit that allows selection and output of one video signal from among the multiple video signals input thereto. The multiplexer 12 is typically controlled by a digital control signal that specifies which signal to select.

FIG. 1B depicts a block diagram of a broadband multiplexer 12 that may be used in the conventional camera switching system 1. The broadband multiplexer 12 includes one high bandwidth switch 13 per input and digital selection logic 14. Each high bandwidth switch 13 receives a high bandwidth input signal comprising a video signal and either outputs the signal or not, depending on the selection signal applied to it from selection logic 14. (If a logical 1 is applied, then the signal is outputted. If a logical 0 is applied, then the signal is not outputted.) The selection logic 14 receives a video output control signal. For example, if the selection logic 14 controls four switches, the control signal may be two bits where the two bits indicate which of the four video signals to output. (For example—If the two bits are 00, then the first video signal may be output. If the two bits are 01, then the second video signal may be output. If the two bits are 10, then the third video signal may be output. If the two bits are 11, then the fourth video signal may be output.) Because the broadband multiplexer 12 must switch high bandwidth video signals while introducing minimal interference, the broadband multiplexer 12 tends to be a substantially expensive component that is prone to be not perfectly reliable.

FIG. 1C depicts a diagram of a camera switching system 2 in accordance with an embodiment of the invention. Like the conventional system 1 of FIG. 1A, the system 2 of FIG. 1C includes multiple video cameras, for example, 10A, 10B, 10C, and 10D.

However, the cameras 10A-D in FIG. 1C have corresponding switches 16A-D which may be integrated into the camera (as illustrated in FIG. 1C) or may be separate from the camera (not illustrated). The latter embodiment (separate from camera) has the advantage of enabling use with conventional cameras. The switches 16A-D are coupled to the power source 11. Each switch 16A-D may switch on or off power to its corresponding camera.

The embodiment of the invention depicted in FIG. 1C advantageously does not require the broadband multiplexer 12 of FIG. 1A. In accordance with the embodiment depicted in FIG. 1C, a video signal OUT is effectively generated by video signals transmitted in parallel, but one at a time, from the cameras 10A-D.

In one embodiment, a wireless transmitter 15A-D (which may be either internal or external) is used by each camera 10A-D to transmit video signals, and a wireless receiver 19 is utilized to receive video signals. The wireless receiver 19 may be embedded, for example, within a set top box or other customer premises equipment. The wireless transmitters 15A-D and receiver 19 may be implemented, for example, using radio-frequency (RF) signals. In one specific embodiment, analog video signals may be transmitted by the cameras 10A-D using RF signals around the 900 MHz or around the 2.4 GHz ranges. The foregoing embodiment advantageously would not need analog-to-digital (A/D) and digital-to-analog (D/A) conversions. In another embodiment, RF transmission under the IEEE 802.11 standard or similar technologies may be used that require A/D and D/A conversions (and also packet assembly and disassembly). Alternatively to the preceding wireless embodiments, cable or other wiring capable of transmitting video signals may be utilized to transmit the video signals from the cameras 10A-D.

In accordance with a specific embodiment of the invention, a camera controller 18 controls which camera of the plurality of cameras 10A-D will have its video signal output at any one time. The camera controller 18 may comprise part of a set top box or other device, or it may comprise a stand-alone device. The camera controller 18 includes a switch controller 17.

The switch controller 17 controls the power switches 16A-D and thereby controls which camera 10-D has power switched on and which cameras 10A-D have power switched off. In accordance with a specific embodiment of the invention, only one camera at a time has power switched on.

In the embodiment illustrated in FIG. 1C, control signals are communicated from the switch controller 17 to the power switches 16A-D using wireless technology to reduce installation work. For example, the switch controller 17 may use a wireless RF transmitter send control signals to wireless RF receivers coupled to the power switches 16A-D. In another embodiment, control signals are communicated between the switch controller 17 and the power switches 16A-D using wired technology. For example, AC power lines that are already provide power to the cameras 10A-D and to the switch controller 17 may be used to communicate control signals from the switch controller 17 to the power switches 16A-D. Advantageously, this embodiment puts the AC power wires to dual use (both to deliver power and control signals). In one specific implementation, commercial X-10 signaling may be used over AC power lines. Alternatively, twisted pair wire or other wiring may be used to transmit the control signals.

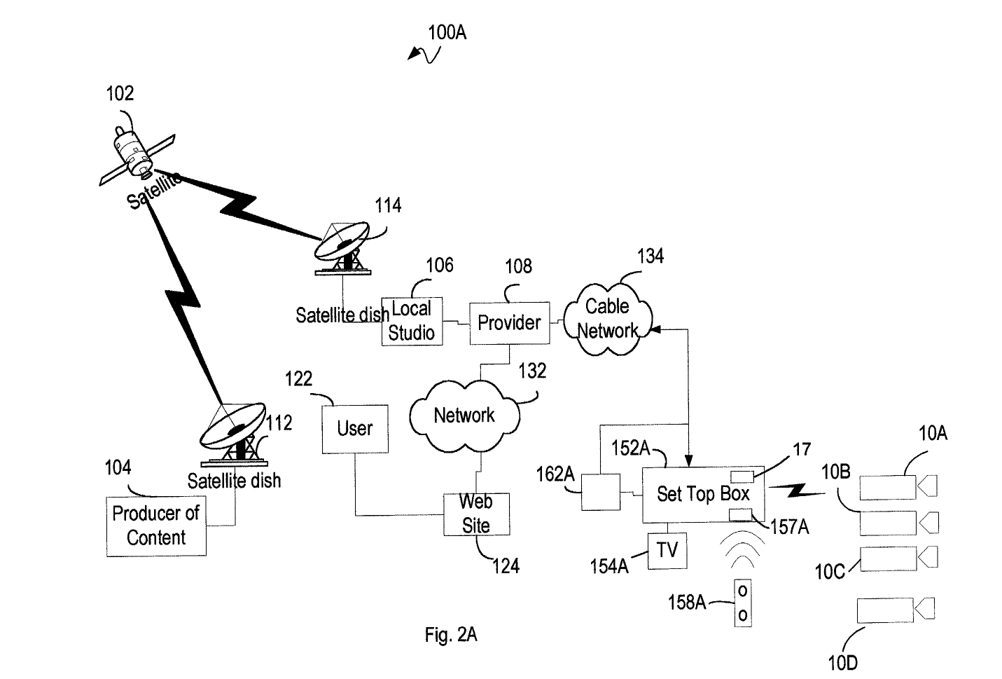

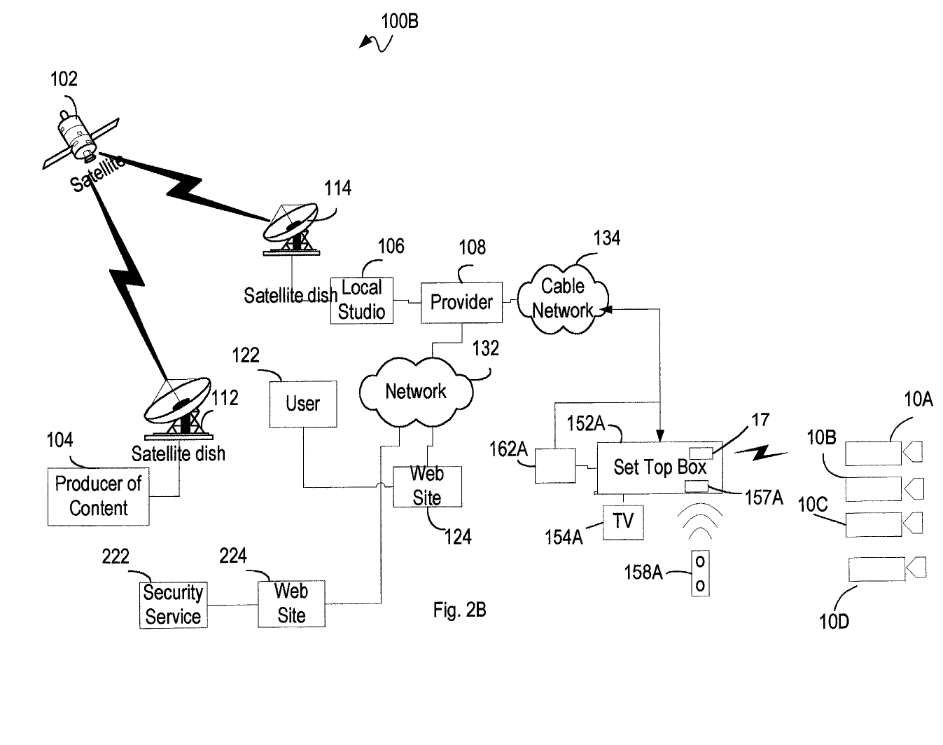

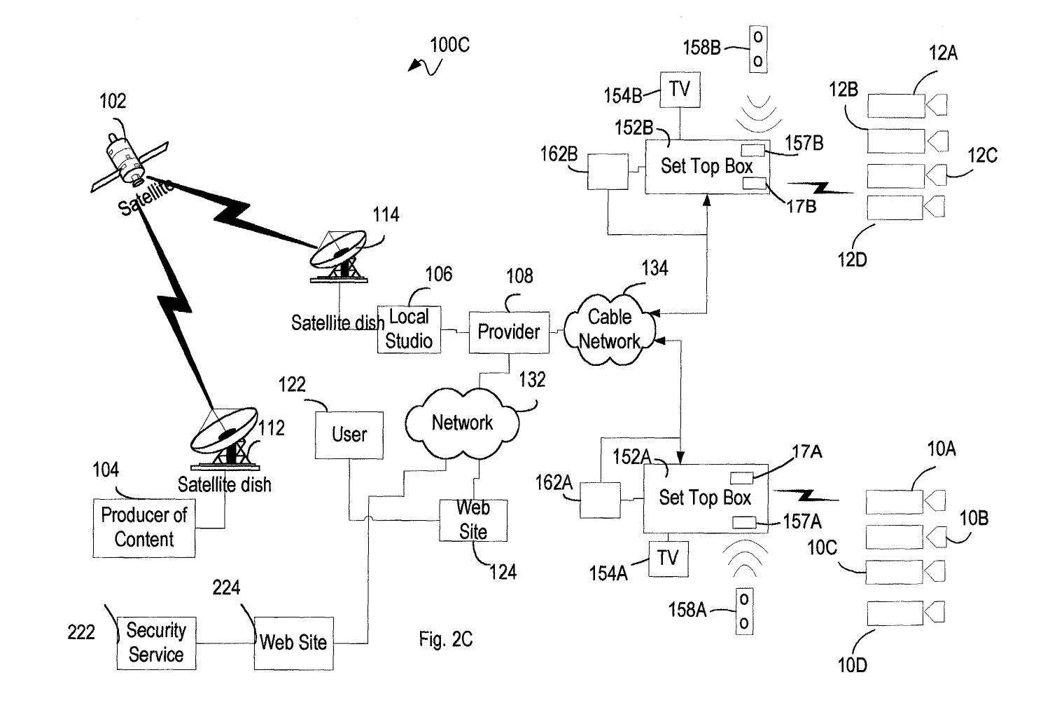

FIG. 2A illustrates a block diagram of an example arrangement of an interactive video casting system in which video monitoring is implemented in a specific embodiment of the present invention. As shown in FIG. 2A, representative video casting system 100 comprises a production company 104 that produces programming content for transmission to viewers. This programming content is sent via satellite transmission transceiver 112 over an uplink channel to a satellite 102. The satellite 102 then transmits the programming content over a downlink channel via a satellite transmission transceiver 114 to a local studio 106, or alternatively to a cable service provider 108. The local studio 106 can insert additional programming (e.g., regional programming) and/or advertisements as needed into the programming content. The content with the insertions is then transmitted from the local studio 106 to a cable service provider 108. The television program may be downloaded to a receiving station, such as a head-end (H/E) (not shown) of the cable service provider 108, rather than or in addition to the local studio 106. In some specific embodiments, a reverse channel from the cable service provider 108 to the local studio 106 is provided so that the local studio 106 can insert additional programming content and feed the television signal back to the cable service provider 108. The cable service provider 108 then delivers the television signal over a cable network 134 to cable subscribers. In various alternative embodiments, the cable network 134 may comprise a broadband digital subscriber line (DSL) or satellite dish deliver system. In addition to video programming and marketing information, monitoring services, including video and/or audio monitoring can be provided by the video casting system 100 in a specific embodiment.

The cable network 134 is provided by the cable service provider 108 to distribute the programming content to cable subscribers. A set top box (STB) 152A, typically located on the premises of a cable television subscriber, receives the programming content or television signal from cable network 134, and delivers the television signal to the subscriber's television set 154A. In some specific embodiments, alternatively or in addition, the television signal can be broadcast over a wireless medium and received by a traditional aerial antenna or by a satellite dish, and then delivered to the set top box 152A. Alternatively or additionally, features and functionality of the set top box 152A may be integrated into a type of advanced television or other customer premises equipment.

Moreover, in specific embodiments, other types of broadcast media, including but not limited to, satellite, very-high-data-rate digital subscriber line (VDSL), web casts, and the like may be used to carry video and/or programming content. The features provided by the television set 154A can also be provided, in a specific embodiment, by a personal computer (PC) suitably configured with an adapter to convert television signals into a digitized format, and then to deliver the television signals to the video portion of the computer for display. It is noted that the invention is not limited to any one configuration of display hardware as embodiments of the invention can be realized using alternative reception and display arrangements, as known to those skilled in the art.

In accordance with an embodiment of the invention, a connection to a communication network is provided for a subscriber to cable services. In one embodiment, the connection can be made via a cable modem in a set top box 152A over a bi-directional cable network 134 to a cable modem termination system within the cable provider's 108 equipment. The cable provider's 108 equipment provides connection to a data communication network 132 which may be coupled to the Internet. In situations where some cable companies are not equipped to provide cable modem service to their customers, various other arrangements known to those skilled in the art can be used. For example, a conventional modem connection can be used to access the Internet over a telephone line. As another example, Internet access can be provided using a Digital Subscriber Line (DSL) connection, or an integrated services digital network (ISDN) connection, using a telephone line. Wireless systems are also available for providing Internet access. In a specific embodiment, downstream data transmission may occur via cable or satellite, and upstream data transmission may occur via a telephone line.

In specific embodiments, the set top box 152A can include a transceiver 157A, such as an infrared (IR) or radio frequency (RF) transceiver, that can exchange signals with a remote control unit 158A or other user input device. The set top box 152A can be a component separate from the television set 154A as shown in FIG. 2A, or its features can be built into circuitry of the television set 154A (e.g., an interactive television set). The set top box 152A enables a viewer to select a television program to view and then delivers the television program to the television set 154A. A storage unit 162A can also be coupled to or be a part of the set top box 152A. The storage unit 162A can include a machine-readable storage medium such as a cache, buffer, memory, or the like and their associated hardware, in one embodiment. In another embodiment the storage unit 162A may include a hard disk.

As noted above, the local studio 106 can insert additional programming into the received transmission; for example, to provide cable content that includes locally provided channels. The programming is then distributed to customers over the cable network 134. In addition to local program insertion, the local studio 106 can insert advertising content, product supplemental information, including information relating to the goods or services being advertised in a commercial, and so forth. Triggers, such as Advanced Television Enhancement Forum (ATVEF) triggers, which are related to the web site 124 and/or to its contents, can be continuously updated as the television broadcast is being received. As noted above, the triggers, resources, or announcements can be inserted by the originating broadcaster 104, a local broadcaster 106, or by the cable system operator 108. In the event of an emergency (for example, earthquake, flood, hurricane, riots, looting, terrorism, etc.), triggers may be sent by the system to activate monitoring cameras to begin transmitting and/or recording video signals. This may be done to provide a richer set of inputs or recording for security and/or intelligence gathering.

In addition to video programming and marketing information, video monitoring services can be made available to the user by the video casting system 100. In one embodiment, the user 122 can obtain access to video information from video cameras 10A, 10B, 10C, and 10D by way of a web site 124 connected with the set top box 152A via network 132, cable service provider equipment 108 and cable network 134.

In a specific embodiment, the features and functionality of the switch controller 17 and summing circuit 15 may be integrated within the set top box 152A or separate from but coupled to the set top box 152A. The video cameras 10A, 10B, 10C, and 10D may then be controlled by the set top box 152A so that they can provide video and/or audio information to the set top box 152A.

In one embodiment, the video and/or audio signals output by the summing circuit 15 may be processed by the set top box 152A to prepare the signals for transmission over network connection 155A, cable net 134 and network 132 to one or more destinations, such as web site 124. In specific embodiments, the set top box 152A compresses the video information and may modify it, in order to send the video information across the networks to the web site 124. For example, in a specific embodiment, the video information modification includes encryption of the video information for secure communication to the web site via the networks 134 and/or 132. In a reverse channel between the web site 124 and the set top box 152A, the web site 124 sends instructions to the set top box 152A across the networks 134 and/or 132 in order to direct the set top box 152A to select one of the video cameras 10A, 10B, and 10C, for example. In a specific embodiment, a client computer receives a web page from a web site's server computer and displays the web page to a user 122. The web site 124 is operative to receive information from a user 122, using a CGI script, for example. Choices from the user 122 are entered into the web page and are processed by a CGI script, which formats the input and forwards it to the server computer. The information from the user 122 can include commands and the like that the web site 124 can use to formulate commands to the set top box 152A. The web site 124 provides the capability to process a video image from the selected video camera's video information and to display the resulting image to the user 122. In some specific embodiments, the web site 124 applies an inverse of any modification applied to the information by the set top box 152A. For example, if the set top box 152A compresses the image prior to transmission over networks 134 and/or 132, the web site 124 decompresses the image. In a specific embodiment, the user 122 can direct the actions of video cameras 10A, 10B, 10C, and 10D in order to obtain video images from using web site 124 via network 132 and cable network 134. Accordingly, the website 124 operates as a “remote access controller” that a user may access and use to control the cameras and view the video and/or audio signals from the selected camera.

Note that Internet access is not necessary to remotely monitor the cameras 10A-D. A private network may be used. The cable provider 108 can supply the foregoing features, for example, by providing a private web site or a “walled garden” that is accessible only by its subscribers. In such configurations, the cable provider 108 serves as an intermediary and allows the user 122 and/or security service 222 to interface to set top boxes 152 in sites to be monitored.

FIG. 2B illustrates a block diagram showing another example of an interactive video casting system in a specific embodiment of the present invention. As shown by FIG. 2B, video casting system 100B includes a web site 224 that is also connected to the network 132. The web site 224 enables a commercial security service 222, for example, to monitor video and/or audio information within the home, office, or place of business of the user 122. Here, the security system user 222, operating web site 224, is located such that the security system user 222 is capable of monitoring activity at the user's home via the video cameras 10A-D, the camera switching system of FIG. 1C, and networks 132 and/or 134, either concurrently with, or in place of, user 122 monitoring the home using web site 124. In some specific embodiments, the user 122 can use the web site 124 to grant permission to the security service 222 to monitor information from video cameras 10A, 10B, and 10C using an access control process. A user 122 may be charged for various services and features. For example, a surcharge may be required for the bandwidth to use a web site 124 to access and switch between the cameras 10A-D.

FIG. 2C illustrates a block diagram showing a further example of an interactive video casting system in a specific embodiment of the present invention. As shown by FIG. 2C, video casting system 100C includes an installation at another location. As illustrated in FIG. 2C, in one specific embodiment, a bi-directional cable network 134 can be used to couple a set top box 152B to a cable modem termination system within the cable provider's 108 equipment. The cable provider's 108 equipment may comprise a head-end and may provide connection to a data communication network 132, such as the Internet. In specific embodiments, the set top box 152B can include a transceiver 157B, such as an infrared (IR) or radio frequency (RF) transceiver, that can exchange signals with a remote control unit 158B or other user input device. The set top box 152B can be a component separate from the television set 154B as shown in FIG. 2C, or its features can be built into circuitry of the television set 154B (e.g., an interactive television set). A storage unit 162B can also be coupled to or be a part of the set top box 152B.

The video cameras 12A, 12B, 12C, and 12D communicate via radio link with the set top box 152B in order to provide video and/or audio information to the set top box 152B. The information from the video cameras 12A-D is processed by the set top box 152B to prepare the information from the cameras for transmission over cable network 134 and network 132 to one or more destinations, such as web site 124.

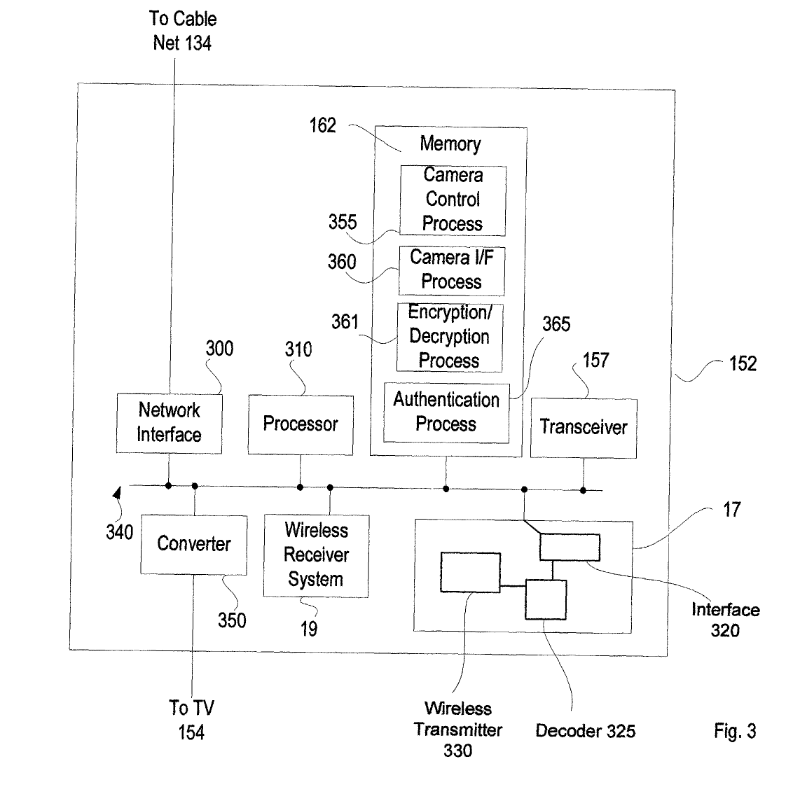

FIG. 3 illustrates a block diagram of a representative set top box (or other customer premise equipment that may be embodied within a television set or personal computer) in a specific embodiment of the present invention. It is noted that the set top box 152 described below is representative of some of the possible embodiments of the set top box 152A and/or 152B shown in FIG. 2A, FIG. 2B, or FIG. 2C. The set top box 152 includes a network interface 300, processor 310, memory device 162 (also referred to as a storage device), transceiver 157, converter 350, receiver system 19, and switch controller 17, all interconnected together, for example, via system bus 340. Network interface 300 connects the set top box 152 to the cable network 134 in FIG. 2A, FIG. 2B, or FIG. 2C. The network interface 300 may include a tuner system to receive television broadcast channels via the cable network 134 and may also include a cable modem for receiving and transmitting data via the cable network 134. Processor (controller) 310 executes instructions stored in memory 162 to perform a variety of functions, such as providing programming from the cable network 134 to the viewer, enabling the viewer, for example, to select programming from an electronic program guide.

In specific embodiments, memory 162 further comprises program code for controlling video cameras 10A-D and/or 12A-D, encrypting/decrypting commands or instructions from remote access controllers, interfacing with the cameras, and authenticating a sender of commands and/or instructions. These program processes may be embodied as a camera control process 355, encryption/decryption process 361, camera interface process 360 and command authentication process 365 as in the representative embodiment illustrated in FIG. 3. In some specific embodiments, the set top box 152 also performs other functionalities not enumerated here, such as conditional access to TV programming. Further, in other embodiments, some of the functionalities described here may not be included in a set top box.

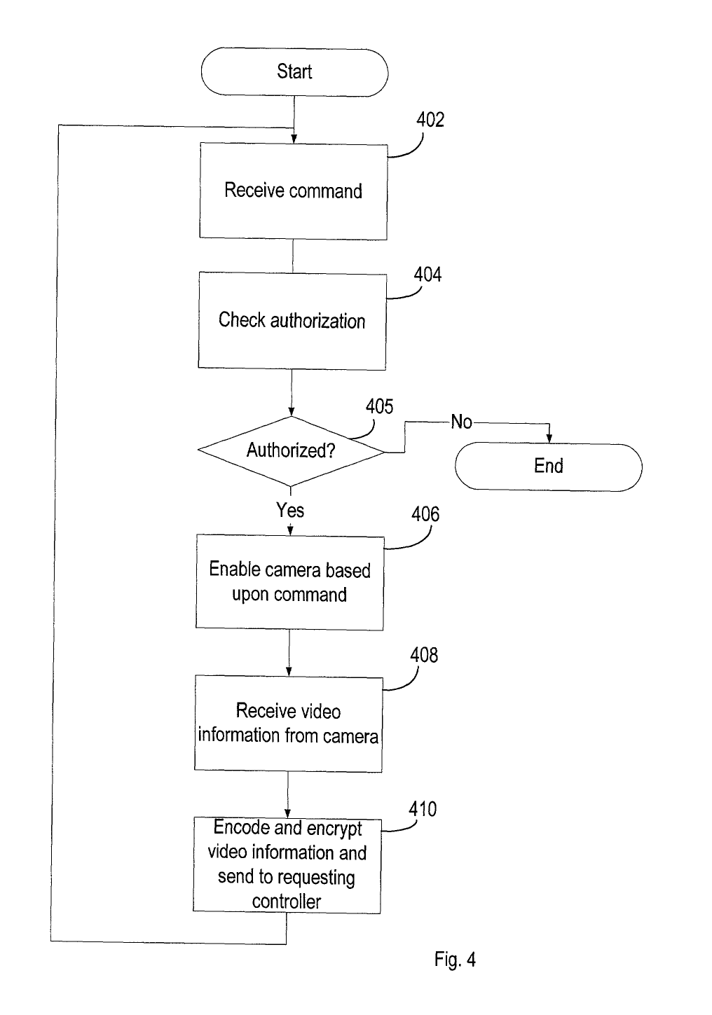

The camera control process 355 coordinates the activities of the video cameras 10A-D and/or 12A-D, handles communications with local and remote access controllers, and manages the other processes. In a specific embodiment, the camera control process 355 waits in a loop for a connection from a local or remote access controller. A representative implementation of camera control process 355 in a specific embodiment is described herein below with reference to FIG. 4. However, a variety of other ways can be used in controlling the cameras.

The camera interface process 360, according to one embodiment of the invention, may convert authorized commands to control codes and provide the control codes to the video cameras 10A-D and/or 12A-D. In various specific embodiments, the control codes can activate the cameras, change configuration of the cameras, and the like.

In a specific embodiment, authentication process 365 verifies any communications received by the set top box 152 to determine that the source of the communications is a local or remote access controller having authorization to communicate with, provide commands and/or instructions to, and receive video and/or audio information from the cameras interfaced with the set top box 152.

There are various different ways that the authentication process 365 can verify the authorization of local and remote access controllers. In accordance with a specific implementation of the authentication process 365, a user's camera controller 18 has access to a designated list of commands it will accept from a command issuer or a group of command issuers. The camera controller 18 also has access to a verified public key for each of the relevant command issuers. When a command is sent to the camera controller 18, the command message is check summed and signed with the private key of the command issuer. The signature and message checksum can then be confirmed by using the publicly available key of the command issuer.

In a specific embodiment, the local or remote access controller includes a graphical user interface (GUI) that enables a user to select from among a plurality of cameras controlled by the camera controller. In a specific embodiment, images generated by the camera may be pre-encoded by the camera in a variety of video formats, including NTSC, PAL, MPEG, MJPEG, etc., for transmission to and decoding by a local or remote access controller. In one embodiment, the signal is encrypted prior to such transmission over a public or private network for security reasons.

There are a variety of ways to implement the camera control process 355, the camera interface (I/F) process 360, encryption/decryption process 361, and authentication process 365 in various specific embodiments. However, in one specific embodiment, these processes may each be implemented as a program module, program instructions, or the like. However, in alternative embodiments, one or more of these processes may be realized in specific hardware, or incorporated into a programmable storage unit, such as a PROM, EPROM, EEPROM, EAPROM, and so forth.

Transceiver 157 can include an IR or RF transceiver that can exchange signals with a remote control unit 158 (FIG. 2A, FIG. 2B, or FIG. 2C) or other user input device. Converter 350 can convert, if necessary, digitally encoded broadcasts to a format usable by TV 154 (FIG. 2A, FIG. 2B, or FIG. 2C). In addition, converter 350 can convert other data received in an out-of-band portion of a broadcast, such as television scheduling information to a format that can be stored in memory 162.

A cable modem that may be incorporated in the network interface 300 may transmit and receive digital information, such as television scheduling information, if not included in the out-of-band portion of a broadcast. In alternative embodiments, a conventional modem for use over telephone lines may be used for transmitting and receiving digital data.

In one embodiment, a wireless receiver system 19 may be incorporated into the set top box 152 for receiving video signals from the video cameras 10A-D. Alternatively, the receiver system 19 may be external to the set top box 152, and instead coupled to the box 152 via an appropriate interface.

In a specific embodiment, a switch controller 17 is incorporated into the set top box 152. The switch controller 17 shown in FIG. 3 includes an interface 320, decoder 325, and a wireless transmitter 330. The interface 320 communicatively couples the switch controller 17 to other components in the set top box 152. The communicative coupling may be implemented, for example, using a bus 340. The decoder 325 receives command codes from, for example, the camera control process 355 and the camera interface process 360. The decoder 325 decodes the command codes to generate command signals for transmission to the cameras 10A-D. The wireless transmitter 330 is coupled to the decoder 325 and transmits the command signals to the cameras 10A-D. For example, if the command is to view camera 10B, then signals are sent to turn power switches 16A, 16C, and 16D off and to turn power switches 16B on.

FIG. 4 illustrates a flowchart of representative processing in a camera controller in a specific embodiment of the present invention. This processing can be performed by the camera controller 18 which may be a stand-alone device or may be incorporated into a set top box 152 or other device.

In a specific embodiment, camera controller 18 waits for instructions. As illustrated by FIG. 4A, a command or instructions is received in a step 402. Next, in a step 404, the identity of the sender of the command is determined from the command, and the authorization of the sender of the command is checked. Then, in a step 405, the command is analyzed to determine if it is a command is authorized. If it is not authorized, then the processing ends.

Otherwise, in a step 406, the command is analyzed to determine which camera is to be activated, and a command to enable the selected camera is broadcast on the radio frequency of the power switches 16 in the cameras in the installation. The camera controller 18 possesses information about the quantity and identification of cameras comprising the installation. In a step 408, video information is received back from the selected camera.

Then, in a step 410, the video information is encoded and encrypted and sent to the local or remote access controller (whichever originated the authorized command requesting the video). The encoding may include compressing or otherwise encoding the video information. The encryption may be implemented, for example, using the public key of the requester of the video (who can then use a corresponding private key for decryption).

In one embodiment, the video information that is sent out may also be stored on a storage device. The storage device may be, for example, a hard drive in the customer premise equipment configured such that a user may review the video information that was sent out.

Thereafter, processing returns to step 402 to process another command from the local or remote access controller.

In specific embodiments, contemporaneously arriving instructions from more than one command source are handled sequentially. In alternative embodiments, a prioritization scheme is used to determine the order in which the multiple instructions are handled. A prioritization depending on a ranking of command sources may be utilized. In one embodiment, a local access controller (for example, within a home) would always have (or default to) the highest priority over remote access controllers. That is unless a law enforcement authority provides an override order that has been electronically countersigned by a proper court authority.

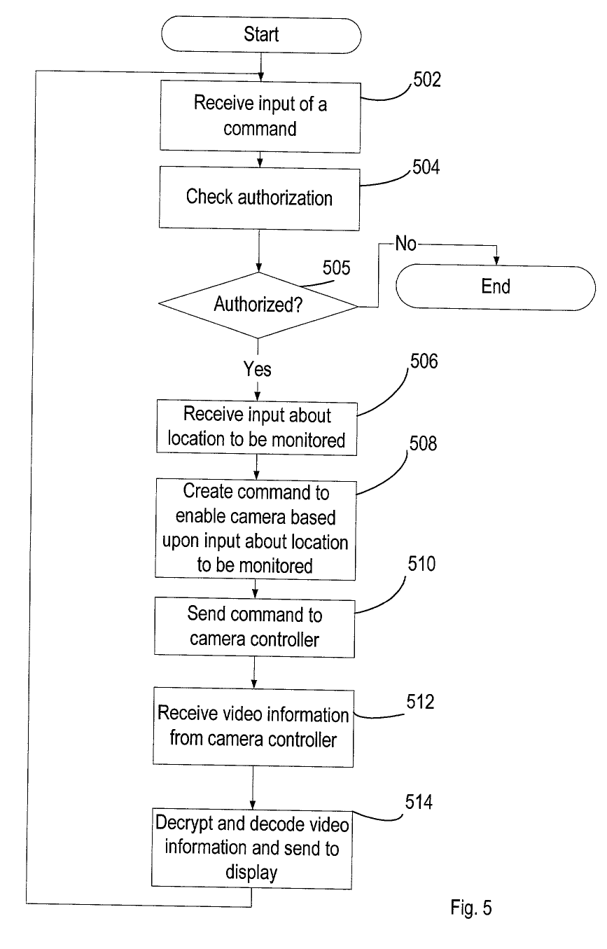

FIG. 5 illustrates a flowchart of representative processing in a local or remote access controller in a specific embodiment of the present invention. In a specific embodiment, a local or remote access controller waits for input from a user. The user is prompted to input a password, or other authorization information. In an alternative embodiment, the access controller may be permitted access to specific camera controllers without the need for the user to input authorization information. Then, in a step 505, the command is analyzed to determine if it is authorized. If not, then processing ends.

Otherwise, in a step 506, the user enters information about a location that the user would like to monitor. In step 508, the input information about a location to be monitored received in step 508 is used to create a command to select an appropriate camera. In a specific embodiment, the location information is converted to an address of an appropriate camera positioned to obtain images in the location where the user wishes to monitor. Then, in a step 510, the local or remote access controller forwards the command to a camera controller appropriate for the camera of interest. The camera controller will decode the command, and if authorized, responds with video information. The video information is received from the camera controller in a step 512.

In step 514, the video information, if encrypted, is decrypted. For example, if the video information was encrypted using a public key of the requestor, then a corresponding private key of the requester may be used to decrypt the video information. The video information may also need decoding, including decompression, before being sent to the display for viewing by the requestor.

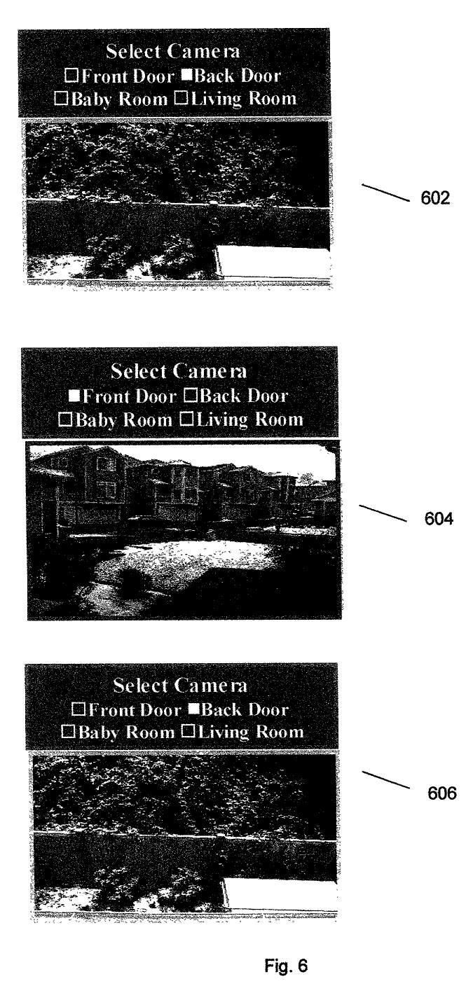

FIG. 6 illustrates a user interface for switching between multiple cameras in accordance with a specific embodiment of the present invention. The example user interface illustrated is designed to monitor a plurality of cameras in a user's home. Three screen shot examples 602, 604, and 606 are shown representing different points in time.

The selection of the camera and the viewing of the video from the selected camera may occur either locally at the home, or remotely away from the home (for example, from an office, or from a relative's home, or from a hotel room while traveling). The upper area of each screen includes an area indicating which camera is selected for viewing.

For example, a viewer may utilize the user interface to select using arrow buttons on a remote control (or mouse or other input device) the back door located camera for viewing. As shown in the top screen 602, the back door located camera is selected, and the upper area indicates this by the solid square before “Back Door.” The lower area of the screen 602 then shows video of the back yard area.

After viewing the back yard, the viewer may utilize the user interface to select, for example, the front door area for viewing. As shown in the middle screen 604, the front door located camera is selected, and the upper area indicates this by the solid square before “Front Door.” The lower area of the screen 604 then shows video of the front door area.

After viewing the front door area, the viewer may utilize the user interface to re-select the back door located camera for viewing. As shown in the bottom screen 606, the back door located camera is re-selected, and the upper area indicates this by the solid square before “Back Door.” The lower area of the screen 606 then shows video of the back yard.

In the description herein, numerous specific details are provided to provide a thorough understanding of embodiments of the invention. One skilled in the relevant art will recognize, however, that the invention can be practiced without one or more of the specific details, or with other methods, components, materials, parts, and the like. In other instances, well-known structures, materials, or operations are not shown or described in detail to avoid obscuring aspects of the invention.

Reference throughout this specification to “one embodiment” or “an embodiment” and the like means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments.

Other variations and modifications of the above-described embodiments and methods are possible in light of the foregoing teaching. For example, the systems, devices, and methods described above may be used in conjunction with other networks besides the specific embodiment of the cable network described above. As another example, the systems, devices, and methods described above may be used to transmit and receive still pictures (instead of video) from the cameras. The still pictures may be transmitted periodically (for example, one every few seconds). Transmitting such still pictures advantageously reduces bandwidth requirements compared to transmitting video. In one embodiment, the system is configured to allow the user to switch between still picture monitoring and video monitoring.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A system for switching between a plurality of video cameras, the system comprising:
a camera controller for controlling the plurality of video cameras;
a plurality of addressable power switches, wherein each addressable power switch is coupled to and controls power applied to a corresponding video camera;
an output device capable of receiving a video signal from any of the plurality of video cameras and configured to output the video signal received; and
a switch controller controlled by the camera controller for addressing the plurality of addressable power switches.

2. The system of claim 1, wherein the switch controller controls application of power to the plurality of video cameras such that power is applied to a single video camera at a time.

3. The system of claim 1, wherein switch controller includes a wireless transmitter, and wherein the addressable power switches includes wireless receivers.

4. The system of claim 3, wherein the wireless transmitter is configured to transmit radio frequency signals to the wireless receivers, and wherein the wireless receivers are configured to receive radio frequency signals from the wireless transmitter.

5. The system of claim 1, wherein the switch controller is integrated into the camera controller.

6. The system of claim 5, wherein the camera controller is integrated into customer premises equipment that is communicatively coupled to a cable network.

7. The system of claim 1, wherein a camera control process provides commands from remote access controllers to the camera controller.

8. The system of claim 7, wherein an authentication process limits commands accepted to only authorized commands.

9. The system of claim 7, wherein an encryption process provides security to video signals transmitted from the camera controller to a remote access controller.

10. The system of claim 1, wherein the plurality of video cameras comprise wireless transmitters for sending video signals to the output device, and wherein the output device comprises a wireless receiver for receiving video signals from the plurality of video cameras.

11. A camera controller for controlling a plurality of video cameras, the camera controller comprising:
a memory configured with a camera control process;
a communication bus coupled to the memory for transmitting command codes from the camera control process; and
a switch controller coupled to the communication bus for receiving the command codes,
wherein the switch controller is configured to use the command codes to control a plurality of addressable power switches that control application of power to the plurality of video cameras.

12. The camera controller of claim 11, wherein the memory is further configured with an authentication process for authenticating remote commands to control the plurality of cameras.

13. The camera controller of claim 12, wherein the memory is further configured with an encryption process to securely transmit video from the camera controller to a requesting controller.

14. The camera controller of claim 11, wherein the switch controller comprises a wireless transmitter for transmitting control signals to the plurality of addressable power switches.

15. The camera controller of claim 14, wherein the switch controller comprises a decoder for decoding the command codes to generate the control signals.

16. The camera controller of claim 11, wherein the camera controller is incorporated into a set top box.

17. The camera controller of claim 11, wherein the camera controller is provided as part of customer premises equipment that is configured to transmit video over a cable network.

18. The camera controller of claim 11, wherein the camera controller is provided as part of customer premises equipment that is configured to transmit video over an Internet.

19. A method for monitoring a plurality of video cameras, the method comprising:
processing a command to view images from a particular camera of the plurality of video cameras to determine if the command is authorized;
if the command is authorized, then generating a control code and communicating the control code to a power switch controller;
decoding the control code to generate control signals, wherein the control signals are configured such that power is applied to a single video camera at a time; and
transmitting the control signals to a plurality of addressable power switches, wherein each addressable power switch is coupled to and controls power applied to a corresponding video camera.

20. The method of claim 19, wherein the transmitting occurs by sending signals over AC power lines that provide power the video cameras and the power switch controller.

21. The method of claim 19, wherein the transmitting occurs by sending control signals over a radio-frequency carrier from the power switch controller to the addressable power switches.

21. The method of claim 19, wherein the plurality of cameras are placed about a premises of a customer.

22. The method of claim 21, wherein the command is received from a local system within the premises of the customer.

23. The method of claim 21, wherein the command is received from a remote system outside the premises of the customer.

24. A system for switching between a plurality of video cameras, the system comprising:
means for processing a command to view images from a particular camera of the plurality of video cameras to determine if the command is authorized;
means for generating a control code and for communicating the control code to a power switch controller if the command is authorized;
means for decoding the control code to generate control signals; and
means for transmitting the control signals to a plurality of addressable power switches,
wherein each addressable power switch is coupled to and controls power applied to a corresponding video camera, and
wherein the control signals are configured such that power is applied to a single video camera at a time.

25. A method for providing access to a plurality of video cameras, the method comprising:
receiving a command from a requestor to view images from a particular camera of the plurality of video cameras, wherein the command as received is encrypted using a private key of the requestor;
decrypting the command by using a public key of the requester to determine if the command is authentic;
processing the command to determine if the command is authorized;
if the command is authentic and authorized, then a) encrypting a video signal from the particular camera by using the public key such that the requestor may decrypt the video signal using the private key and b) transmitting the encrypted video signal to the requestor.
